(19) United States
(12) Patent Application Publication
(10) Pub. No.: US 2008/0226125 A1
(43) Pub. Date: Sep. 18, 2008

(54) Method of Embedding Data in an Information Signal

(75) Inventor: Adriaan Johan Van Leest, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,177

(22) PCT Filed: Oct. 16, 2006
(86) PCT No.: PCT/IB06/53803

§ 371 Date: Apr. 23, 2008

(30) Foreign Application Priority Data
Oct. 26, 2005 (EP) 05110026.1

(51) Int. Cl. G06K 9/00

(52) U.S. Cl. 382/100

(57) ABSTRACT

This invention relates to a watermarking scheme that is robust to general distortions such as scaling and rotation of multimedia content (audio, video, images). This is achieved by embedding a watermark in a first component of the host signal and a transformed version of the same watermark in a second component. For example, a watermark is embedded in the luminance component (Y) and a cyclically shifted version thereof in the chrominance component (UV) of a video signal. The detector correlates (46) the luminance watermark with all cyclicly shifted versions of the chrominance watermark. The highest correlation peak indicates the shift that was applied at the embedder end. By comparing the shift thus found with the original value, the scaling and rotation factors are retrieved (47). The invention allows the scaling and rotation operations to be undone, after which the embedded watermark can reliably be detected in a conventional manner.

The present invention relates to a method of embedding data in an information signal. The present invention also relates to a method of recovering data embedded in an information signal. In particular, but not exclusively, the present invention relates to a method of embedding data such that the data is robust to modification or degradation of the information signal and can be recovered.

Currently, it is easy to obtain and distribute digital data representing information signals (such as images and sounds) using networks of computers connected together, for example via the Internet.

However, this facilitated distribution of data presents a problem for the owners of copyright in such data. For example, it is known for media files, such as video files, to be distributed and copied in violation of copyright laws. Such distribution and copying results in the owners of the respective copyright not receiving royalties to which they are entitled. Similar problems occur with other forms of media files, such as music files.

In order to prevent and detect such unauthorised copying and distribution it is known to embed digital watermarks within information signals. Digital watermarks may provide a mechanism of validating the authenticity of the information signal. Alternatively, digital watermarks may be used for forensic purposes to detect unauthorised copies of information signals. Digital watermarks commonly include a name of the copyright owner, an identity of a purchaser and a tag such as “copy never”, “copy once” or “copy no more”. The tags are used to prevent unauthorised copies from being created. For example, an MPEG video file tagged “copy never” will prevent the MPEG file from being copied using copying hardware and software able to read the tag. Similarly, an MPEG file tagged “copy once” will allow a single copy to be made. The new copy will be tagged “copy never” and the tag on the original MPEG file will be amended to be “copy no more”.

Nowadays, watermarking techniques are seen in a wider perspective, in which a watermark is a message that is transmitted by an encoder to a decoder via a noisy channel. The noisy channel is typically a sound, image or video signal. On receipt a watermark decoder makes an estimate of the received message. Modification (e.g. scaling) of the sound, image or video signal can make it harder to estimate the received watermark message.

When digital watermarks are embedded into audio or video data the watermarks are only faintly added, in order not to perceptibly degrade or distort the data. Meanwhile, the audio or video data may be changing rapidly and significantly over time. In consequence, in order to allow retrieval of watermark data from video data it is known to accumulate watermark information over a series of frames stored in a buffer and then to apply correlation techniques using one or more expected watermark templates in order to prove or disprove the presence of the watermark in the video data.

However, it is known that spatial correlation to recover watermark data is extremely difficult, if not virtually impossible, to implement unless the original scale of the video content is known, or the scale factor of the video content is known. There are a number of known methods of finding the scale factor.

One known watermarking scheme employs watermark patterns embedded in a video signal. The watermark patterns may be repeated in a tiled pattern, according to a known spatial grid, throughout each image in the video signal. The images are auto-correlated resulting in a grid of peaks dependent upon the embedded watermark. A measure of the scale factor can be derived by comparing the grid of peaks with the original watermark. The original scale factor corresponds to a position of a correlation peak in the correlated data. Such a scheme is described in the following publications: US patent application publication number US 2002/0114490, Kutter: “Watermarking resistant to translation, rotation and scaling”, Proc SPIE volume 3528, Multimedia systems and applications, 1998 and Termont et al: “How to achieve robustness against scaling in a real-time digital watermarking system for broadcast monitoring”, Proc IEEE International Conference on Image Processing, 1998.

However, watermarking schemes using tiled watermarks suffer from a number of disadvantages. Firstly, tiled watermarks are degraded when the format of the video data is changed. This particularly is the case if sampling takes place during the conversion process; the watermark pattern may end up at a very limited resolution, and potentially too small to be useful.

Furthermore, if the images are cropped or scaled, the images may become too small in the vertical direction to include two complete vertically adjacent watermark tiles, making retrieval of the vertical scale factor difficult. Also, if the image is too small, due to cropping, then the correlation peak corresponding to the correct scale factor will be small, with the risk that this will be lost in the background “noise” of the video signal.

Another known method of retrieving the scale uses the Fourier-Mellin transformation. This is described in Lin et al: “Rotation, scale and translation resilient watermarking for images”, IEEE Trans Image Processing, 2001 and O'Ruanaidh et al: “Rotation, scale and translation invariant digital image watermarking”, Proc IEEE International Conference on Image Processing, 1997. This involves performing a log-polar mapping of a Fourier transformed image. However, a disadvantage of this approach is that the discrete implementation of this mapping and transformation and their inverse are computationally intensive and sensitive to errors.

In non-prepublished European Patent Application No. 04102007.4 (Applicant's docket PHNL040497) a digital watermarking technique has been proposed in which the geometrical properties of a watermark are temporally changed throughout video data comprising a sequence of images. The images are grouped into consecutive groups of images and the geometrical properties of the watermark are changed between the groups. A watermark detector is able to process images from different groups and analyse the retrieved watermark data to derive a scaling factor for the video content data. For example, a watermark embedder is arranged to embed a standard watermark pattern in an original position in the first 600 image frames in the sequence of images. In the next 600 frames the embedder embeds the watermark in a transformed format. The transformed watermark may be mirrored and/or spatially translated and/or rotated. Typically, the transformed watermark comprises the original watermark shifted by a predetermined number of pixels in both the horizontal and the vertical directions. In the following 600 frames the embedder embeds the original watermark, and so on.

If the video content is scaled then both the original watermark and the transformed watermark will also be scaled accordingly. The watermark decoder is arranged to retrieve the sequence of images and sort the images into a first group containing the original watermark and a second group containing the transformed watermark. The watermark decoder has knowledge of the original transformation between the watermarks embedded in the two groups. Therefore, by mutually analysing the two groups the watermark decoder can determine one or more changes to the watermarks and thus how the transformation has changed, thereby retrieving a scale factor relating to the scaling of the video content relative to the original video content signal. The original watermark data can then be recovered.

However, a disadvantage of this approach is that the watermark decoder must be time synchronised with the watermark embedder in order to sort the images into the two groups. This is because the watermark decoder needs to know when each series of frames starts and finishes in order to have the highest correlation. This time synchronisation can be difficult to achieve without some further communication between the embedder and the decoder, or additional information being added to the video data. Lack of synchronisation between the watermark embedder and the watermark decoder can lead to incorrect detection of the watermark, due to the original and the transformed watermarks interfering with each other. As a consequence, the retrieved scale factor may be incorrect. This can mean that the watermark data cannot be recovered.

It is an object of the present invention to obviate or mitigate one or more of the problems of the prior art. It is a specific object of embodiments of the present invention to provide a video watermarking scheme that is robust to scaling and rotation of the video content.

According to a first aspect of the present invention there is provided a method of embedding data in an information signal, the method comprising embedding the data in a first component of the information signal and embedding a transformed version of the data in a second component of the information signal.

An advantage of the present invention is that by embedding data in the first component of the information signal and, preferably simultaneously, a transformed version of the data in the second component of the information signal, this allows recovery of the data if the information signal has been scaled, rotated or mirrored. The scale, rotation or mirroring parameters can be recovered and used to recover the original data. Preferred embodiments of the present invention are also robust to more general geometrical distortions of the information signal, for instance translation, cropping, altering the aspect ratio and skewing.

Preferably, the information signal comprises a video signal. The first component may comprise a luminance component of the video signal and the second component may comprise a chrominance component of the video signal. This is advantageous because it allows data to be embedded in a video signal such that the data is recoverable if the video signal is transformed, for instance by scaling. By embedding data in the luminance and chrominance components this ensures that a decoder does not need to be time synchronised to a data embedder.

Preferably, the video signal comprises a series of images. The method may comprise embedding the data in the first component of the information signal in each image and embedding the transformed version of the data in the second component of the information signal in each image. This is advantageous because this aids the recovery of the data and the transformed version of the data by buffering and then correlating the series of images.

Preferably, the data comprises a two dimensional array of watermark data. This allows watermarks to be added to information signals such as video signals for copyright enforcement.

Preferably, the method further comprises cyclically shifting said data in at least a first direction to create the transformed version of the data. This allows recovery of the transformation at a decoder and therefore recovery of any transformations that have been applied to the information signal, by comparison with the original transformation. Cyclically shifting the data means that the transformed data is offset relative to the original data such that it “wraps round”. This ensures that the offset data is not lost.

Preferably, shifting said watermark data in at least a first direction comprises shifting said data by half the length of the two-dimensional array of watermark data in the first direction. This improves the accuracy of later recovery of the embedded data. Preferably, the method further comprises up-sampling the two-dimensional array of data in at least a first direction. Advantageously, this allows the method to be applied to video signals in which the chrominance component of the signal has been down-sampled, without resulting in a reduction in the resolution of the transformed version of the data.

Preferably, embedding a transformed version of the data in a second component of the information signal comprises embedding first and second transformed versions of the data in the second component of the information signal. Advantageously, this allows retrieval of an additional transformation parameter of the information signal.

Preferably, the method further comprises embedding the first and second transformed versions of the data with opposite polarities. This aids the detection of both transformed versions as they can be identified by inspecting the respective signs of the correlation peaks at a decoder.

According to a second aspect of the present invention there is provided a carrier medium carrying computer readable code for controlling a computer to carry out the above described method.

According to a third aspect of the present invention there is provided a computer apparatus for embedding data in an information signal, the apparatus comprising a program memory storing processor readable instructions and a processor configured to read and execute instructions stored in said program memory wherein the processor readable instructions comprise instructions controlling the processor to carry out the above described method.

According to a fourth aspect of the present invention there is provided an apparatus for embedding data in an information signal, the apparatus comprising a first data embedder adapted to embed the data in a first component of the information signal and a second data embedder adapted to embed a transformed version of the data in a second component of the information signal.

According to a fifth aspect of the present invention there is provided a method of recovering data embedded in an information signal, the method comprising correlating data embedded in a first component of the information signal with a transformed version of the data embedded in a second component of the information signal.

An advantage of the fifth aspect of the present invention is that by correlating the data and the transformed version of the data a transformation matrix can be recovered allowing recovery of the original data.

Preferably, the video signal comprises a series of images, the method further comprising buffering the series of images, and splitting the series of images into the first and second components. This improves the method of recovery of the data by increasing the accuracy of recovery of a transformation matrix.

Preferably, the method further comprises computing the absolute value of the estimate of the transformed version of the data embedded in the second component. This avoids the possibility of ambiguous recovery of the data.

Preferably, the method further comprises high pass filtering the estimate of the data embedded in the first component and the estimate of the transformed version of the data embedded in the second component. This improves the data to information signal ratio, improving the recovery of the data.

Preferably, the method further comprises correlating the estimate of the transformed version of the data embedded in the second component with transformed versions of the estimate of the data embedded in the first component to identify a transformation that provides a correlation peak. The transformation that provides the correlation peak can then be used to recover the original data by comparing the transformation that provides a correlation peak with a known transformation between the data embedded in the first component of the information signal and the transformed version of the data embedded in the second component of the information signal to recover a transformation matrix.

According to a sixth aspect of the present invention there is provided a carrier medium carrying computer readable code for controlling a computer to carry out the above described method

According to a seventh aspect of the present invention there is provided a computer apparatus for recovering data embedded in an information signal, the apparatus comprising a program memory storing processor readable instructions and a processor configured to read and execute instructions stored in said program memory, wherein the processor readable instructions comprise instructions controlling the processor to carry out the above described method.

According to an eighth aspect of the present invention there is provided an apparatus for recovering data embedded in an information signal, the apparatus comprising a correlator adapted to correlate data embedded in a first component of the information signal with a transformed version of the data embedded in a second component of the information signal.

The present invention will now be described, by way of example only, with reference to the accompanying drawings, in which:

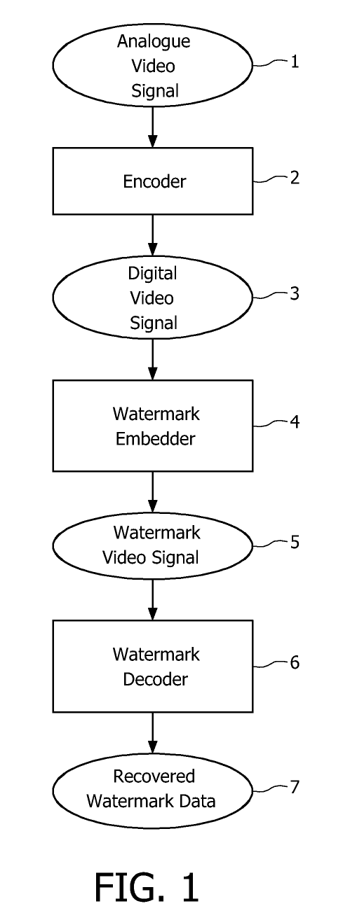

FIG. 1 is a schematic illustration of an overview of a processes involved in digitising an analogue signal, embedding a watermark in that signal in accordance with an embodiment of the present invention and decoding the watermarked signal to recover the watermark data;

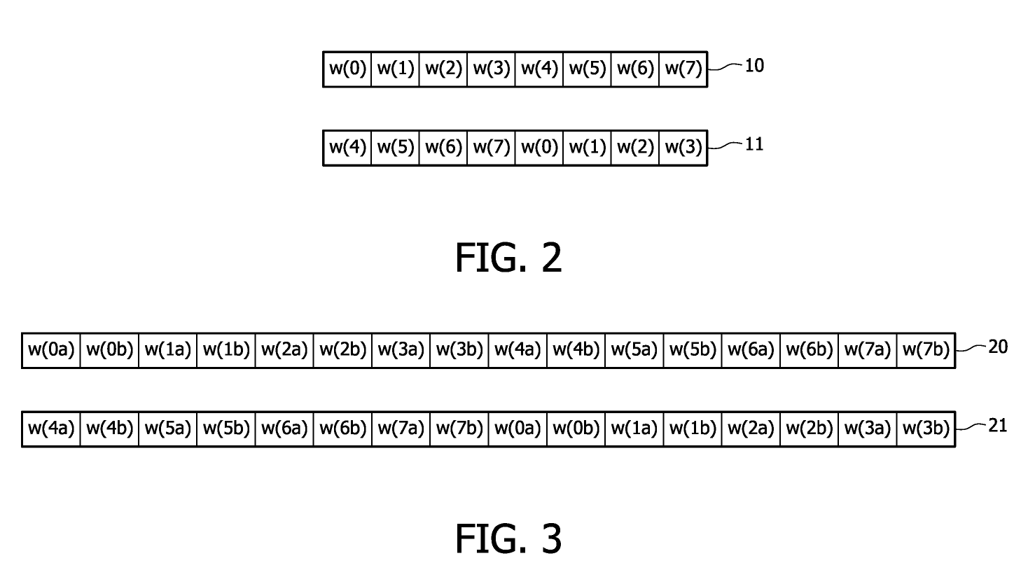

FIG. 2 is a schematic illustration of a one-dimensional watermark and a cyclically shifted copy of the one-dimensional watermark;

FIG. 3 is a schematic illustration of the watermark and cyclically shifted watermark of FIG. 2 after scaling;

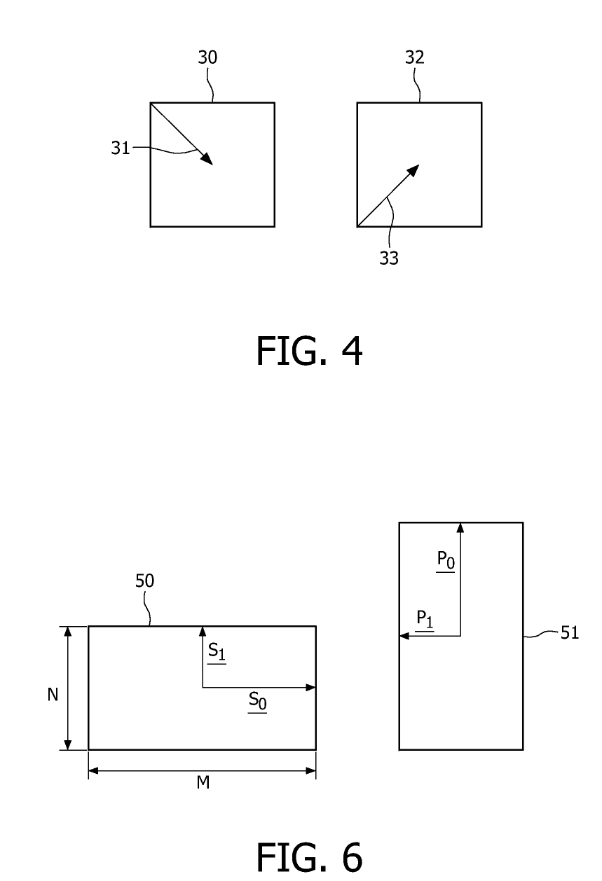

FIG. 4 schematically illustrates the effect of rotating an embedded watermark and a cyclically shifted embedded watermark;

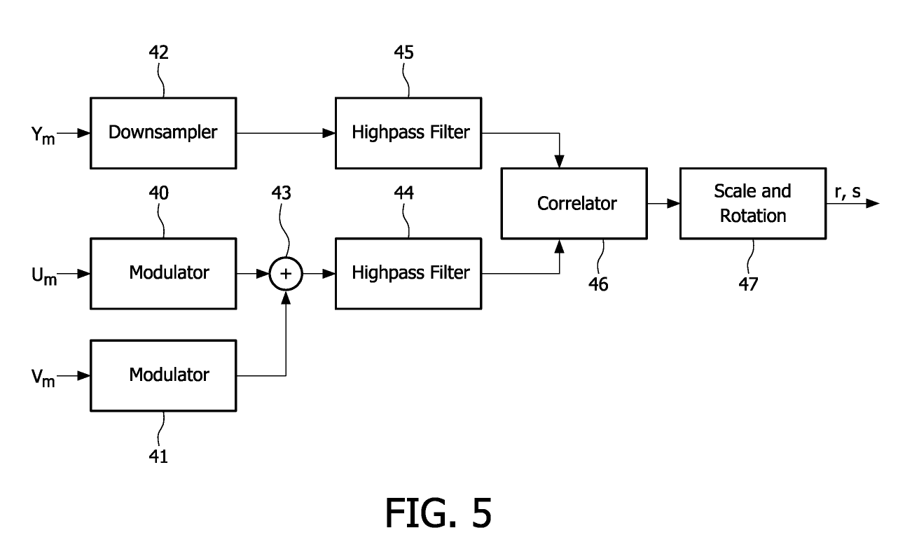

FIG. 5 is a schematic illustration of a watermark decoder in accordance with an embodiment of the present invention for decoding the embedded watermarks of FIG. 4;

FIG. 6 schematically illustrates the effect of rotating an embedded watermark and two cyclically shifted embedded watermarks; and

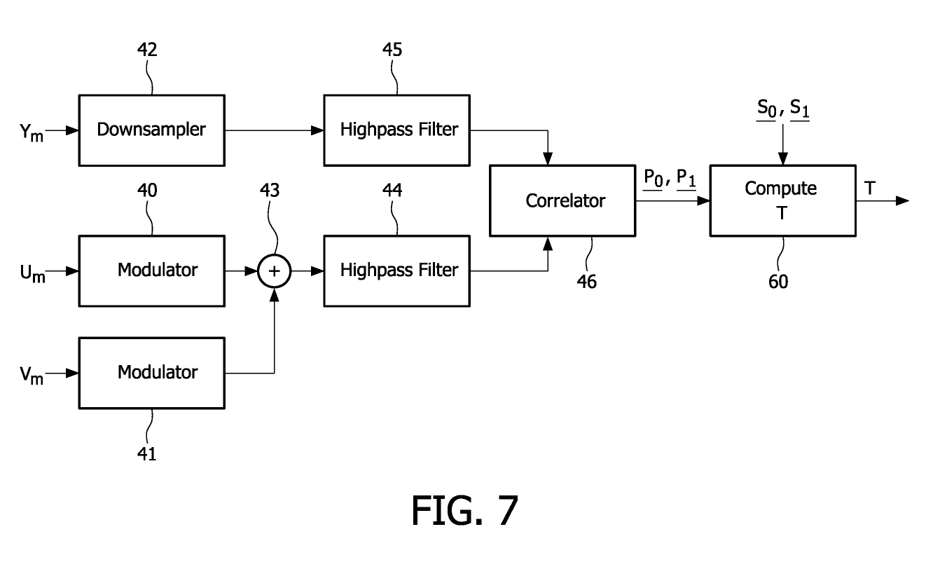

FIG. 7 is a schematic illustration of a watermark decoder in accordance with an embodiment of the present invention for decoding the embedded watermarks of FIG. 6.

As shown in FIG. 1, an analogue video signal 1 is received by an encoder 2. The encoder 2 may be an MPEG encoder 2 arranged to digitise and compress the analogue video signal 1 into a digital video signal 3 (such as an MPEG stream, which is a data format created by the Moving Pictures Experts Group) for subsequent broadcast or storage. The digital video signal 3 is received by a watermark embedder 4. The watermark embedder 4 embeds a watermark into the digital video signal 3, generating a watermarked video signal 5. The watermarked video signal 5 is subsequently transmitted and/or retrieved, eventually being decoded by a watermark decoder 6. The watermark decoder 6 recovers the watermark data 7. The watermark is imperceptibly hidden within the watermarked digital video signal 5 so that users will not be able to detect its presence when viewing the reconstituted version of the original analogue video stream 1.

The present invention overcomes a problem of lack of synchronisation between two embedded watermarks (an original and a transformed watermark) by exploiting the colour information of a video signal instead of the temporal axis of the video signal. The original watermark is embedded in a luminance component of the video images and the transformed watermark is embedded in a chrominance component of the video images (or vice versa). This provides robustness against scaling of the video images by allowing the retrieval of a scale factor. The watermarking scheme is also robust to rotation or mirroring of the video content. Due to the temporal alignment of the luminance and the chrominance components of the image data a watermarking scheme according to the present invention does not require the watermark decoder to be synchronised with the watermark embedder. Due to the spatial alignment of the luminance and chrominance components, scale and rotation factor retrieval is also robust against more general geometrical distortions as exactly the same distortion is applied to both watermarks.

Colour video signals can be modelled using a Red Green Blue (RGB) Colour Model. This is an additive model, which utilises the way red, green and blue light can be added together to make other colours. Each pixel in a video signal is given three independent values, which are the intensity of the red, green, and blue light required for that pixel to give the correct colour. The RGB colour model is commonly used for the display colours on a video monitor or television. By using the appropriate combination of red, green and blue light intensities the screen can reproduce any colour between black and white. Typically, each RGB value corresponds to an 8-bit number, giving 256 different levels of red, green and blue. With this system, approximately 16.7 million discrete colours can be reproduced.

An alternative colour model is the YUV colour model, which, for instance, is used in the PAL system of television broadcasting within Europe and elsewhere. Y represents the luminance component (the brightness) and U and V are the chrominance (colour) components. There are a number of alternative colour models having a Y component and scaled versions of the U and V components. YUV signals are created from an original RGB source signal by weighted addition of the R, G and B values, for example by using the following equations:

Y=0.299R+0.587G+0.114B

U=0.492(B−Y)=−0.147R−0.289G+0.436B

V=0.877(R−Y)=0.615R−0.515G−0.100B

At a television or monitor the RGB values can be recovered from the YUV values in order to supply the correct signals to each pixel. The advantage of the YUV colour model over the RGB colour model is that it is backwards compatible with black and white television signals. The Y signal is essentially the same signal that would be broadcast for a black and white television signal, while the U and V signals can be ignored. Additionally, as the human eye has fairly low resolution for colour, in modified versions of the YUV colour model the amount of information transmitted in the U and V components can be reduced by down-sampling to save bandwidth.

Although the present invention will be described here primarily with reference to the YUV colour model, it is not limited to this. Indeed any colour model having at least two separate components, such as RGB or equivalents to YUV may be used. The process of embedding watermark data within a video signal, and recovering that watermark data, will now be described with reference to FIGS. 2 to 7.

In a preferred embodiment of the present invention, a watermark is embedded in the luminance component of a digital video signal, and a cyclically shifted version of the same watermark is embedded in the chrominance component of the digital video signal. The watermark is typically a two-dimensional matrix pattern. The watermark may be comparable with the size of an image or frame of the video signal, or it may only overlie a small proportion of the image frame. The watermark may be tiled across the frame. The watermark is embedded by slightly altering the luminance and/or chrominance values for each pixel.

Referring to FIG. 2, the method of embedding a cyclically shifted version of the watermark can be more simply explained with reference to a one-dimensional example.

FIG. 2 depicts a one-dimensional watermark 10, which is eight elements long. The elements are numbered w(0) to w(7). The lower watermark 11 is a cyclically shifted (i.e. laterally shifted such that it wraps round) version of watermark 10, also having eight elements numbered w(0) to w(7). It can be seen that the lower watermark 11 is equivalent to the upper watermark 10 shifted four elements to the left, such that it starts with element w(4). The upper watermark 10 is embedded in the luminance component of the digital video signal 3 and the lower watermark 11 is embedded in the chrominance component of the digital video signal 3. It will be appreciated that this could alternatively be viewed as the upper watermark 10 being cyclically shifted with respect to the lower watermark 11.

Upper and lower watermarks 10, 11 may be considered to be a single watermark w, which may be shifted to the left or the right. Watermark w is a vector, which is eight elements long.

A shift operator, S^{k}, is defined as the relationship between the upper and lower watermarks 10, 11. k indicates the number of places the shift operator S cyclically shifts the watermark w to the left. If the upper watermark 10 is set as the generic watermark w, then lower mark 11 is equivalent to (S⁴w), i.e. w shifted four places to the left.

Watermark w is arranged such that it is not correlated to cyclically shifted versions of itself:

$$〈 w , ( {S}^{k} w ) 〉 = {\sum }_{l} δ [ k - lN ] , \\ ∀ k ∈ Z$$

Where N is the length of the watermark;

l is a counter;

[symbol] w, (S^{k}w) [symbol] denotes the correlation between watermark w and a version of itself shift by k places; and

δ[k] is a Kronecker delta with δ[0]=1 and δ[k]=1 for kεZ\{0} (where Z denotes integers).

The correlation between watermark w and a version of itself shifted by 0 elements or a multiple of watermark N elements is equal to 1 (k=0, i.e. effectively no shift). The correlation is equal to 0 for any other value of k (i.e. any shift to the left or right of watermark w by an amount other than a multiple of the length of the watermark N).

The shift operator S^{k} is defined as:

(S^{k}x)(n)=x(n−k)

Where: x is a vector and x(n) is the n^{th} element of vector x,

(S^{k}x) is a vector produced when vector x has been shifted by k places. In other words if vector x is shifted by k places then each element of the new vector is equal to the element of vector x, k places to the right of that position.

As stated above, upper watermark 10 of FIG. 2 is watermark w and lower watermark 11 is S⁴w. If the upper watermark 10 and the lower watermark 11 are correlated then:

[symbol]

w,(S⁴w) [symbol] =0 (i.e. there is no correlation)

However, if the lower watermark 11 is correlated with all possible cyclically shifted versions of the upper watermark 10 then there is only a correlation peak if the upper watermark 10 is cyclically shifted by four elements (or a multiple of the length of the watermark N plus four elements), that is:

[symbol]

(S⁴w),(S⁴w) [symbol] =1

Referring now to FIG. 3, the watermarked digital signal 5, including the upper and lower watermarks 10, 11, has been scaled before being received by the watermark decoder 6. The watermarks have been scaled by a scale factor of 2. Scaled watermark 20 corresponds to the upper (luminance) watermark 10 of FIG. 2. Scaled watermark 21 corresponds to the lower (chrominance) watermark 11 of FIG. 2.

Each element of the original watermarks 10, 11 now occupies the position of two elements in the scaled watermarks 20, 21. For example, original element w(1) now corresponds to scaled elements w(1a) and w(1b). The extra elements correspond to interpolated versions of the elements of the original watermarks.

If the chrominance watermark 21 is correlated with all possible cyclically shifted versions of the luminance watermark 20 then there is only a correlation peak if the luminance watermark is shifted by eight elements:

[symbol]

(S⁸w),(S⁸w) [symbol] =1

As it is known that the original cyclical shift was 4 elements, it can readily be deduced from correlating the luminance and chrominance watermarks at the watermark decoder 6 that the scale factor is 2, using only the information contained within the received watermarked digital video signal 4 and knowledge of the original transformation. As a first step, the watermark decoder 6 estimates the luminance and chrominance watermarks within the respective components of a series of received images within the watermarked digital video signal 5. The watermark decoder then correlates the estimated luminance watermark with all possible shifted versions of the estimated chrominance watermark (or the other way round). This yields one or more relatively high correlation peaks. Due to degradation or modification of the video signal, the correlation peak, or peaks, may be less than 1, leading to some uncertainty as to whether the precise watermarks have been recovered.

Once the scale factor has been computed, the watermark decoder 6 is able to correlate the original watermark, or a series of possible original watermarks (which it has access to via another channel) and the estimated luminance (or chrominance) watermark. This will indicate which watermark is present in the watermarked digital video signal.

In the case of a two dimensional cyclical shift, i.e. for a two dimensional watermark shifted in both horizontal and vertical directions, both horizontal and vertical scale factors can be computed. Furthermore, if the video images are rotated, the angle of rotation can also be determined. This is explained with reference to FIG. 4. FIG. 4 shows two watermarks. A first watermark 30 is embedded in the luminance component of the digital video signal 3. A horizontally and vertically cyclically shifted version of watermark 30 is embedded in the chrominance component. Vector 31 indicates the shift between the watermarks embedded in the luminance and chrominance components respectively. After rotation of the watermarked digital video signal 5 by 90°, the result is watermark 32 in the luminance component of the watermarked digital video signal 5. The shift between the luminance watermark and the chrominance watermark is now depicted by vector 33. It can be seen that vector 33 is equivalent to vector 31 rotated by the same amount as the digital video signal (i.e. 90°). For convenience, the possibility of any additional scaling of the watermarked digital video signal 5 has been disregarded.

At the watermark decoder 6, vector 33 can be computed by correlating the chrominance watermark with all possible shifted versions of the luminance watermark. As the watermark decoder 6 knows the original direction of the vector 31 the rotation factor can be computed, and hence recover the watermark data.

If it is considered that the watermarked digital video signal may have been subjected to scaling as well as rotation, then by applying the same procedure of correlating the luminance and chrominance components to recover the rotated watermarks, the chrominance watermark can be correlated with all possible horizontally and vertically cyclically shifted versions of the luminance watermark 30 to recover the scaling factor.

The accuracy of the possible rotation factor and scaling factor, is proportional to the length of vector 31. Accuracy is therefore achieved by cyclically shifting the luminance watermark by half of the horizontal length and half the vertical length of the watermark before embedding in the chrominance component. For example, if the luminance watermark is 360*240 elements (or pixels), then the chrominance watermark is shifted by 180 elements in the horizontal direction and 120 elements in the vertical direction. As it is a cyclical shift then a shift of over half the horizontal or vertical length is equivalent to a smaller negative shift.

The scale and rotation factor recovery mechanism described above is also robust to other kinds of geometrical distortions. For example, if some pixels are distorted, for example due to bending or warping of the image, then the luminance and chrominance components are distorted by the same amount. It is still possible to recover the watermark data despite the distortion.

If the watermarked digital video signal 5 is mirrored then this could lead to an ambiguous result, or failure to detect the watermark, for a single watermark embedded in the luminance component and a single watermark embedded in the chrominance component.

In practice, real digital video signals 3 often have a down-sampled chrominance component. This is because the human eye is less sensitive to the chrominance resolution than the luminance resolution. Therefore, by down-sampling only the chrominance component, band width may be saved in the digital video signal 3, without perceptibly degrading the digital video signal 3. Commonly, the chrominance component is down-sampled by a factor of two in the horizontal and vertical directions (referred to as 4:2:0 sub-sampling). This means that an image of size 720*480 pixels has a 720*480 luminance resolution, but only a 360*240 chrominance resolution.

In order to fit with the reduced chrominance resolution it is necessary to down-sample the watermark embedded in the chrominance component by a factor of two in the horizontal and vertical directions. The watermark decoder must then up-sample the chrominance watermark before correlation. However, due to this down-sampling, the amount of high frequency information held within the chrominance watermark is reduced, resulting in a reduced correlation peak, which may be undetectable.

Therefore, in order to avoid this reduction in the correlation peak if a 4:4:4 sub-sampled video signal is converted to a 4:2:2 sub-sampled video signal, instead of embedding a watermark of size 360*240 in both the luminance and chrominance components, the luminance and chrominance watermarks are first up-sampled by a factor of two to 720*480. The chrominance watermark is effectively down-sampled when the chrominance component of the watermarked digital video signal is down-sampled. Therefore, all of the frequencies are still present and the correlation will be much higher. The luminance watermark may need to be down-sampled at the watermark decoder.

Alternatively, if the down-sampling of the chrominance component takes place before the watermarks are embedded then the luminance watermark is up-sampled by a factor of two and the chrominance watermark is embedded at the original size. Again, the luminance watermark may need to be down-sampled at the watermark decoder before the watermarks can be correlated.

As a further option, the chrominance component may only be down-sampled in the horizontal direction (referred to as 4:2:2 sub-sampling). If the luminance and chrominance watermarks are up-sampled, then at the watermark decoder the chrominance watermark is a higher resolution in the vertical direction relative to the horizontal direction. The watermark decoder can down-sample the luminance watermark in both the horizontal and the vertical direction and down-sample the chrominance watermark only in the vertical direction.

The watermark is embedded in the chrominance component by altering the colour saturation of the appropriate pixel. If the watermark element for that pixel is equal to one, then the pixel colour saturation is imperceptibly increased. If the watermark element for that pixel is equal to zero, then the pixel colour saturation is imperceptibly decreased.

In order to reduce the degradation of the video signal caused by embedding a watermark, the watermark embedder may only alter pixels that can be imperceptibly changed. This may require modification of the watermark pattern in response to the content of the video signal.

The colour saturation is modified by multiplying the U and V component of a pixel by a constant c. The value of the constant c is selected independent upon whether the watermark has a value of ‘0’ or ‘1’ for a particular pixel. The constant c has a value close to ‘1’, but can vary from pixel to pixel to make the modification imperceptible. The constant c has a value greater than 1 if the watermark has a ‘1’ value and a value less than 1 if the watermark has a ‘0’ value. For example, if the original U and V values for a pixel are 64 and 163 respectively (within a range of 0-255 for an 8-bit representation of the values), the colour saturation is modified as follows:

Uₘ==c(U−128)+128=c(64−128)+128=128−64c

Vₘ=c(V−128)+128=c(163−128)+128=35c+128

The constant c has a value close to 1. If c>1 then the saturation is increased. If c<1 then the saturation is decreased. A negative chrominance value will become smaller when the saturation increases, i.e. when a watermark w(n)=1 is embedded. This can be compensated for at the detector (see below, with reference to FIG. 5). Both the U and V values are modified simultaneously. The modified Y value is computed as follows:

Yₘ=Y+λ,

Where λ is larger or equal to 0 if the watermark has a ‘1’ value and smaller or equal to 0 if the watermark has a value 0′.

FIG. 5 is a schematic illustration of the operation of a detector in accordance with the present invention. The YUV values are sub-sampled according to a 4:2:0 sub-sampling scheme (i.e. the chrominance component of the digital video signal is down-sampled in the horizontal and vertical directions with respect to the chrominance watermark for a 4:4:4 sub-sampling scheme). For the purposes of FIG. 5, it is assumed that the chrominance values are already within the range −128 to 127 (i.e. that 128 has already been subtracted from the chrominance values).

In order to compensate for the possibility of the original chrominance value being negative (i.e. the chrominance value decreasing when c>1) the Uₘ and Vₘ values are passed through modulators 40 and 41 respectively, such that the absolute values of Uₘ and Vₘ are obtained. The Yₘ value is down-sampled (either horizontally, vertically or both) in down-sampler 42, as discussed above for the option in which the down-sampling of the chrominance component of the watermarked digital video signal 5 occurs after the chrominance watermark is embedded. For a 4:2:2 sub-sampling scheme it may be necessary to down-sample the Uₘ and Vₘ values in the vertical direction.

The absolute values of the Uₘ and Vₘ values are preferably added together in adder 43. However, this addition is not strictly necessary as the watermark decoder can estimate the watermark embedded in the chrominance component from just the Uₘ or Vₘ value. The combined chrominance value and the luminance value are passed through high pass filters 44 and 45. The high pass filters whiten the signals, which helps in estimating the watermark. This is because the watermark energy is low relative to the energy of the digital video signal. However, at higher frequencies, the watermark energy is relatively higher. Therefore, by high pass filtering the modified YUV values, this increases the watermark to signal energy ratio. This is known as matched filtering. Alternatively, the image and the watermark to be detected may be subjected to Symmetrical Phase Only Matched Filtering (SPOMF) in place of the illustrated High pass filtering prior to correlation. This is described in WO99/45707 (Philips). SPOMF exploits the insight that the correlation of the information signal and the applied watermark for a number of possible positions of the watermark is best computed in the Fourier domain, and that the robustness and reliability of detection can be improved by applying SPOMF to the information signal and the watermark before correlation. SPOMF, postulates that most of the relevant information needed for correlation detection is carried by the phase of Fourier coefficients. The magnitudes of the complex Fourier coefficients are normalized to have substantially the same magnitudes.

The high pass filtered chrominance value is then correlated with cyclically shifted versions of the high pass filtered luminance value in correlator 46. Based on the position of the highest correlation peak, the scale factor s and the rotation factor r can be computed by scale and rotation factor computer 47. This can then be used to recover the original watermark data by correlating the recovered watermark with possible versions of the original watermark.

According to the method of embedding and recovering data in an information signal described above, it is only possible to recover the scale factor and the rotation factor when the aspect ratio of the watermarked digital video signal 5 at the watermark decoder 6 is unchanged from that at the watermark encoder 4. Alternatively, if the angle of rotation is known then a change in aspect ratio can be recovered. As mentioned above, if the video content is mirrored then this can lead to ambiguous recovery of the watermark data, or total inability to recover the watermark data.

This can be overcome by embedding an additional cyclically shifted watermark in the chrominance component. Both watermarks embedded in the chrominance component are cyclically shifted versions of the watermark embedded in the luminance component. These two watermarks represent two independent vectors (i.e. the shift from the luminance watermark). The two vectors allow recovery of additional transformations parameters applied to the watermarked digital video signal 5, and hence recovery of the watermark data. Specifically, it is possible to determine horizontal and vertical scale factors with possible change in the aspect ratio, rotation and mirroring of the watermarks.

This may be explained as follows. A watermark w is embedded in the luminance component of a digital video frame of size M*N pixels. For convenience, it is assumed that the resolution of the chrominance component is the same, although it will be appreciated that the same up-sampling approach as described above may be applied here. A watermark v is embedded in the chrominance component of the digital video signal. The chrominance watermark v comprises two cyclically shifted versions of the luminance watermark as follows:

v=(S^{s}^{₀}−w)−(S^{s}^{₁}−w)

The shift operator S is as defined above, with S^{s} corresponding to a two dimensional cyclic shift operator with s being a vector of length two with integer elements. In other words s(0) is the horizontal shift and s(1) is the vertical shift. Therefore, S^{s} may alternatively be written as:

(S^{s}x)(n)=x(n−s)

sεZ²

n is a two dimensional vector representing the n^{th} element of the vector x. As before, the cyclically shifted versions of the luminance watermark are not correlated with the luminance watermark:

[symbol]

w,(S^{w}) [symbol] =δ[S^{s}]

sεZ²

The shifts s₀ and s₁ are not necessarily equal. For example, s₀=(M/2,0) and s₁=(0,N/2). This is illustrated in FIG. 6, where 50 is the watermark embedded in the luminance component and the vectors s₀ and s₁ are shown. The vectors indicate in which direction and by how many pixels the watermarks are shifted. The watermark that is cyclically shifted over s₁ has a negative sign while the watermark that is shifted over s₀ has a positive sign. This makes it possible to distinguish the two watermarks: if v is correlated with all possible cyclically shifted versions of w a positive peak is found at (M/2,0) and a negative peak is found at (0,N/2). Any pair of shifts may be used as long as the vectors s₀ and s₁ are independent of each other.

If the video content is scaled, rotated and/or mirrored then vectors s₀ and s₁ are modified accordingly. For example, if the video content is rotated by 90° a modified luminance watermark 51 is obtained with transformed vectors p₀ and p₁ as shown in FIG. 6. More generally, if the transformation T is applied to the video content then the vectors s₀ and s₁ are mapped to the vectors Tₛ_{₀} and Tₛ_{₁} respectively. For example, in the case of rotation of 90° counter clockwise, transformation T is given by:

$$T = [ \begin{matrix}0 & - 1 \\ 1 & 0\end{matrix} ]$$

The watermark decoder is required to find which transformation was applied to the video content in order to recover the watermark data. This may be determined from: P=T.S

S is a matrix having the two original vectors s₀ and s₁ as columns. P is a matrix having the two transformed vectors p₀ and p₁ as columns. Therefore:

T=P.S⁻¹

As matrix S must be inverted, the vectors s₀ and s₁ must be independent.

The watermark decoder knows s₀ and s₁ and determines p₀ and p₁ by correlating the chrominance watermarks with all the cyclically shifted versions of the luminance watermark. When the watermark decoder has recovered transformation matrix T then it can recover the original watermark data by correlating the luminance watermark with all possible versions of the original watermark.

FIG. 7 schematically depicts a watermark decoder suitable for recovering transformation matrix T, and hence the original watermark data for a watermarking scheme as described above having two cyclically shifted watermarks embedded in the chrominance component. This is identical to the watermark decoder depicted in FIG. 5 except that correlator 46 recovers the two vectors p₀ and p₁. There is also the additional transformation T recovery step 60, before recovery of the watermark data.

As a further modification to increase the watermark to signal ratio, the watermark decoder may buffer a number of frames before decoding the signal (not shown in the decoders of FIGS. 5 and 7). Since the same watermarks are embedded in consecutive frames, the watermarks add up coherently while the video signal does not.

It will be readily appreciated by the appropriately skilled person that various modifications may be made to the preferred embodiments of the present invention described above. In particular, the embodiments are described with reference to an arrangement for embedding a watermark in a video signal. The present invention is, however, neither restricted to video signals nor to a particular standard. For instance, digital video signals encoded using the RGB colour model or equivalents to YUV may be watermarked using the present invention as long as there are at least two components of the signal.

Although the present invention is of particular use for watermarking data streams representative of video streams it is envisaged that the present invention could be used to embed watermarks in other types of digital or analog data streams, for instance digital audio signals in which the digital signal is separated into at least two components, and a separate watermark can be embedded into each components. For instance, for a stereo digital audio signal, the watermark and the transformed watermark could be separately embedded in the left and right audio channel. Alternatively, a first watermark can be embedded in a first frequency sub-band and a second, shifted watermark can be embedded in a second separate frequency sub-band. Other methods of embedding a first watermark and a second transformed watermark into information signals will be readily apparent to the appropriately skilled person. The present invention can also be used to re-mark data streams that already possess digital watermarks. Further modifications and applications of the present invention will be readily apparent to the appropriately skilled person from the teaching herein, without departing from the scope of the appended claims.

In summary, a watermarking scheme is disclosed that is robust to general distortions such as scaling and rotation of multimedia content (audio, video, images). This is achieved by embedding a watermark in a first component of the host signal and a transformed version of the same watermark in a second component. For example, a watermark is embedded in the luminance component (Y) and a cyclically shifted version thereof in the chrominance component (UV) of a video signal. The detector correlates (46) the luminance watermark with all cyclicly shifted versions of the chrominance watermark. The highest correlation peak indicates the shift that was applied at the embedder end. By comparing the shift thus found with the original value, the scaling and rotation factors are retrieved (47). The invention allows the scaling and rotation operations to be undone, after which the embedded watermark can reliably be detected in a conventional manner.

1. A method of embedding data in an information signal, the method comprising:
embedding the data in a first component of the information signal; and
embedding a transformed version of the data in a second component of the information signal.

2. A method according to claim 1, wherein the information signal comprises a video signal, the first component comprises a luminance component of the video signal and the second component comprises a chrominance component of the video signal.

3. A method according to claim 2, wherein the video signal comprises a series of images, the method comprising:
embedding the data in the first component of the information signal in each image; and
embedding the transformed version of the data in the second component of the information signal in each image.

4. A method according to claim 3, wherein the data comprises a two dimensional array of watermark data.

5. A method according to claim 4, further comprising cyclically shifting said data in at least a first direction to create the transformed version of the data.

6. A method according to claim 5, wherein shifting said watermark data in at least a first direction comprises shifting said data by half the length of the two-dimensional array of watermark data in the first direction

7. A method according to claim 5, further comprising shifting said data in a second direction orthogonal to the first direction.

8. A method according to claim 1, wherein embedding a transformed version of the data in said second component comprises embedding first and second transformed versions of the data in the second component of the information signal.

9. A method according to claim 8, further comprising shifting said data along a first vector to create the first transformed version of the data and shifting said data along a second vector to create the second transformed version of the data.

10. A method according to claim 9, further comprising embedding the first and second transformed versions of the data with opposite polarities.

11. (canceled)

12. A computer apparatus for embedding data in an information signal, the apparatus comprising:
a program memory for storing processor readable instructions; and
a processor configured to read and execute instructions stored in said program memory;
wherein the processor readable instructions comprise instructions controlling the processor to embed the data in a first component of the information signal and embed a transformed version of the data in a second component of the information signal.

13. An apparatus for embedding data in an information signal, the apparatus comprising:
a first data embedder adapted to embed the data in a first component of the information signal; and
a second data embedder adapted to embed a transformed version of the data in a second component of the information signal.

14. A method of recovering data embedded in an information signal, the method comprising:
correlating data embedded in a first component of the information signal with a transformed version of the data embedded in a second component of the information signal.

15. A method according to claim 14, wherein the information signal comprises a video signal, the first component comprises a luminance component of the video signal and the second component comprises a chrominance component of the video signal.

16. A method according to claim 14, wherein correlating the data embedded in the first component of the information signal with the transformed version of the data embedded in the second component of the information signal comprises:
estimating the data embedded in the first component;
estimating the transformed version of the data embedded in the second component; and
correlating the estimate of the data embedded in the first component with the estimate of the transformed version of the data embedded in the second component.

17. A method according to claim 14, wherein the data comprises a two-dimensional array of watermark data.

18. A method according to claim 17, further comprising correlating the estimate of the transformed version of the data embedded in the second component with transformed versions of the estimate of the data embedded in the first component to identify a transformation that provides a correlation peak.

19. A method according to claim 18, further comprising comparing the transformation that provides a correlation peak with a known transformation between the data embedded in the first component of the information signal and the transformed version of the data embedded in the second component of the information signal to recover a transformation matrix.

20. A method according to claim 19, further comprising using the transformation matrix to recover the data embedded in the first component of the information signal.

21. (canceled)

22. (canceled)

23. (canceled)
